(19) United States
(12) Patent Application Publication
(10) Pub. No.: US 2009/0247352 A1
(43) Pub. Date: Oct. 1, 2009

(54) POWER TRANSMISSION DEVICE

(75) Inventors: Misaki Kamiya, Anjo-shi (JP); Shoji Takahashi, Okazaki-shi (JP); Mitsugi Yamashita, Anjo-shi (JP)

Correspondence Address: SUGHRUE MION, PLLC, 2100 PENNSYLVANIA AVENUE, N.W., SUITE 800, WASHINGTON, DC, 20037, US

(73) Assignee: AISIN AW CO., LTD., Anjo-shi (JP)

(21) Appl. No.: 12/406,414

(22) Filed: Mar. 18, 2009

(30) Foreign Application Priority Data
Mar. 31, 2008 (JP) 2008-089831

(51) Int. Cl. F16H 57/04; F16H 15/42

(52) U.S. Cl. 476/8; 476/52

(57) ABSTRACT

A partition plate is provided in a case to separate a first space where a CVT is disposed and a second space where a forward/backward travel switching mechanism and a differential gear are disposed. Bearings respectively supporting an input cone and an output cone and formed as pure rolling cylindrical roller bearings are disposed in the first space. A bearing supporting one end of an input shaft and formed as a conical roller bearing capable of receiving thrust force, a bearing supporting an output shaft and formed as a conical roller bearing capable of receiving thrust force, and a bearing supporting one end of the output cone are disposed in the second space. The first space and the second space are sealed by oil seals. The first space is filled with traction oil and the second space is filled with lubricating oil.

### INCORPORATION BY REFERENCE

The disclosure of Japanese Patent Application No. 2008-089831 filed on Mar. 31, 2008, including the specification, drawings and abstract is incorporated herein by reference in its entirety.

### BACKGROUND OF THE INVENTION

The present invention generally relates to a power transmission device. More particularly, the present invention relates to a power transmission device which includes a continuously variable transmission having an input shaft and an output shaft provided in parallel with the input shaft for continuously shifting power applied to the input shaft and outputting the resultant power to the output shaft.

### DESCRIPTION OF THE RELATED ART

As this type of power transmission, it has been proposed a power transmission device including an continuously variable transmission in which a conical member connected to an input shaft and a conical member connected to an output shaft are disposed in parallel with each other in opposite directions and a ring is inserted around one conical member so as to be squeezed by the two conical members (see, for example, Japanese Translation of PCT International Application No. 2006-501425). In this device, by moving the ring in an axial direction, the gear ratio is changed and power applied to the input shaft is output to the output shaft through the ring.

In the above type of power transmission device, the ring is squeezed between the two conical members, and power is transmitted by searing force of an oil film in an elastohydrodynamic lubricating state formed between the ring and the two conical members. It is therefore typical to use traction oil having a high pressure-viscosity coefficient in order to ensure a high traction coefficient. In order to desirably lubricate bearings rotatably supporting the conical members and other mechanical portions, it is also typical to supply lubricating oil to these mechanical portions. It is conceivable to divide a traction transmitting portion, bearings located at both ends of the traction transmitting portion, and other mechanical portions into three or more spaces and to fill each space with corresponding oil. However, this structure causes problems such as complicating the shape of a case and increasing the overall size of the device. It is also conceivable to add an additive so that the traction oil can also lubricate the bearings and other mechanical portions. However, adding the additive may degrade traction performance.

### SUMMARY OF THE INVENTION

It is an aspect of a power transmission device of the present invention to implement reduction in size of the device while ensuring both traction performance and lubrication performance.

The power transmission device of the present invention may employ the following units in order to achieve the above aspects.

A power transmission device according to one aspect of the present invention is a power transmission device including a continuously variable transmission having an input shaft and an output shaft provided in parallel with the input shaft for continuously shifting power applied to the input shaft and outputting the resultant power to the output shaft. The power transmission device includes: an input member having a conical shape and including the input shaft; an output member having substantially the same conical shape as that of the input member, including the output shaft, and disposed in an opposite direction to that of the input shaft; an annular transmitting member squeezed by the input member and the output member for transmitting power received from the input member to the output member; a slide unit capable of changing a gear ratio by sliding the transmitting member; a first bearing attached to one end side of the input member and required to be lubricated with lubricating oil; a second bearing attached to the other end side of the input member, being of a different kind from that of the first bearing, and capable of being lubricated with torque transmitting oil; a third bearing attached to one end side of the output member on the same side as that on which the first bearing is attached, and required to be lubricated with the lubricating oil; a fourth bearing attached to the other end side of the output member, being of a different kind from that of the third bearing, and capable of being lubricated with the torque transmitting oil; and a case accommodating members of the power transmission device, defining together with a seal member a first space where the input member, the output member, the transmitting member, the slide unit, the second bearing, and the fourth bearing are disposed and a second space where the first bearing and the third bearing are disposed. The first space is filled with the torque transmitting oil and the second space is filled with the lubricating oil.

The above power transmission device according to this aspect of the present invention is formed by: the input member having a conical shape and including the input shaft; the output member having substantially the same conical shape as that of the input member, including the output shaft, and disposed in the opposite direction to that of the input shaft; the annular transmitting member squeezed by the input member and the output member for transmitting the power received from the input member to the output member; and the slide unit capable of changing the gear ratio by sliding the transmitting member. The first bearing required to be lubricated with lubricating oil is attached to one end side of the input member. The second bearing that is of a different kind from that of the first bearing and is capable of being lubricated with torque transmitting oil is attached to the other end side of the input member. The third bearing required to be lubricated with the lubricating oil is attached to one end side of the output member on the same side as that on which the first bearing is attached. The fourth bearing that is of a different kind from that of the third bearing and is capable of being lubricated with the torque transmitting oil is attached to the other end side of the output member. The case is structured so as to accommodate the members of the power transmission device and to define together with the seal member the first space where the input member, the output member, the transmitting member, the slide unit, the second bearing, and the fourth bearing are disposed and the second space where the first bearing and the third bearing are disposed. The first space is filled with the torque transmitting oil and the second space is filled with the lubricating oil. The case and the seal member can thus be disposed so as to form two spaces, that is, the first space filled with the torque transmitting oil and the second space filled with the lubricating oil. Accordingly, reduction in size may be implemented while assuring both traction performance and lubrication performance.

In the power transmission device according to another aspect of the present invention, the first bearing and the third bearing may be bearings that can receive thrust force, and the second bearing and the fourth bearing may be pure rolling bearings that cannot receive the thrust force. In this case, the first bearing and the third bearing may be conical roller bearings and the second bearing and the fourth bearing may be cylindrical roller bearings.

In the power transmission device according to another aspect of the present invention, a rotation switching mechanism formed by gears for switching received power between normal rotation and reverse rotation and outputting the resultant power to the input shaft may be disposed in the second space. In this case, the rotation switching mechanism can be lubricated more desirably.

In the power transmission device according to another aspect of the present invention, a differential mechanism connected to the output shaft for outputting power of the output shaft to two other shafts may be disposed in the second space. In this case, the differential mechanism can be lubricated more desirably.

### BRIEF DESCRIPTION OF THE DRAWINGS

FIG. 1 is a structural diagram showing the outline of a structure of a power transmission device 20 according to an embodiment of the present invention;

FIG. 2A and FIG. 2B show diagrams illustrating shifting states of a CVT 30;

FIG. 3 is a structural diagram showing the outline of a structure of a power transmission device 20B of a comparative example;

FIG. 4A and FIG. 4B show structural diagrams showing the outline of a structure of a squeezing force adjusting mechanism 50; and

FIG. 5A and FIG. 5B show partially enlarged views of the squeezing force adjusting mechanism 50.

### DETAILED DESCRIPTION OF THE EMBODIMENTS

The various aspects and features of the present invention and methods of accomplishing the same may be understood more readily by reference to the following detailed description of embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the present invention to those skilled in the art, and the present invention will only be defined by the appended claims. Hereinafter, best modes for carrying out the present invention will be described based on an embodiment.

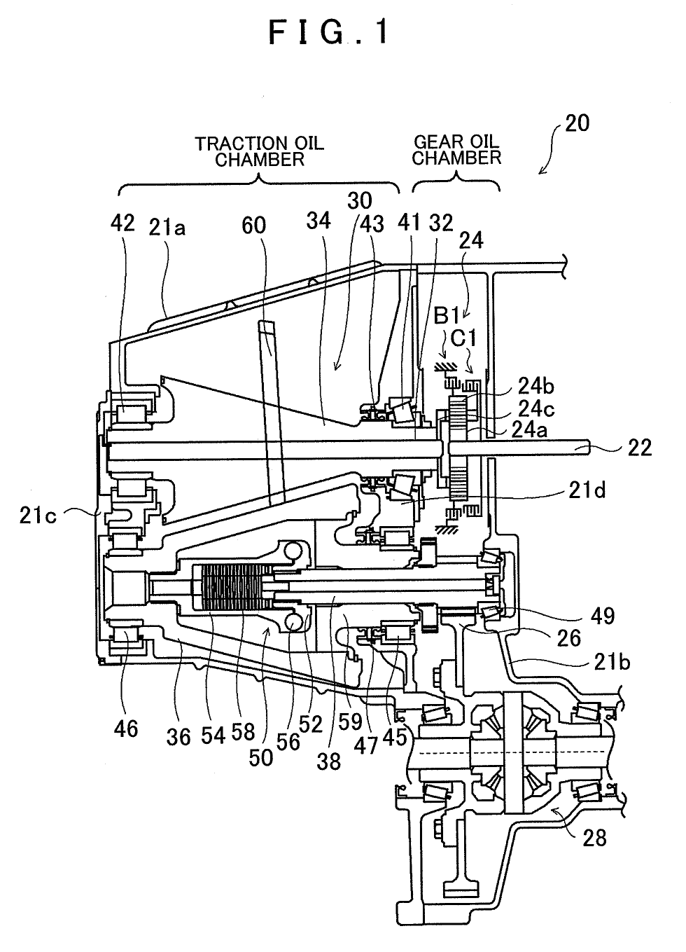

FIG. 1 is a structural diagram showing the outline of a structure of a power transmission device 20 according to an embodiment of the present invention. The power transmission device 20 of the embodiment is structured as a transaxle device capable of shifting power received from an engine (not shown) mounted in a vehicle through a starting device (e.g., a torque converter and the like) and transmitting the resultant power to right and left front wheels. As shown in the figure, the power transmission device 20 includes a forward/backward travel switching mechanism 24, a CVT 30 as a continuously variable transmission, and a differential gear 28. The forward/backward travel switching mechanism 24 is connected to a starter output shaft 22. The forward/backward travel switching mechanism 24 switches power received from the starting device to be delivered in either of a normal rotation or a reverse rotation and outputs the resultant power in either the normal rotation or the reverse rotation to the CVT 30. The CVT 30 has an input shaft 32 connected to the forward/backward travel switching mechanism 24 and a transmission output shaft 38 provided in parallel with the input shaft 32. The CVT 30 continuously shifts power applied to the input shaft 32 and outputs the resultant power to the transmission output shaft 38. The differential gear 28 is connected to the transmission output shaft 38 of the CVT 30 through a speed reduction gear 26 and is connected to the right and left front wheels. The forward/backward travel switching mechanism 24, the CVT 30, and the differential gear 28 are accommodated in a case 21 formed by a transaxle housing 21a, a converter housing 21b, and a rear case 21c. Note that a partition plate 21d for separating a space where the forward/backward travel switching mechanism 24 and the differential gear 28 are disposed and a space where the CVT 30 is disposed is provided in this case 21.

The forward/rearward travel switching mechanism 24 according to this embodiment is formed by a double pinion planetary gear mechanism, a brake B1, and a clutch C1. The double pinion planetary gear mechanism includes a sun gear 24a as an external gear, a ring gear 24b as an internal gear, and a carrier 24c. The ring gear 24b is provided concentrically with the sun gear 24a. The carrier 24c connects a plurality of first pinion gears meshing with the sun gear 24a and a plurality of second pinion gears meshing with the first pinion gears and the ring gear 24b, and holds the plurality of first pinion gears and the plurality of second pinion gears so that the plurality of first pinions gears and the plurality of second pinion gears can rotate and revolve simultaneously. The starter output shaft 22 is connected to the sun gear 24a, and the input shaft 32 of the CVT 30 is connected to the carrier 24c. The ring gear 24b of the planetary gear mechanism is connected to the case 21 by the brake B1. Turning on and off the brake B1 allows the ring gear 24b to rotate freely and inhibits the rotation of the ring gear 24b. The sun gear 24a and the carrier 24c of the planetary gear mechanism are connected by the clutch C1. The sun gear 24a and the carrier 24c are connected and disconnected by turning on and off the clutch C1. By turning off the brake B1 and turning on the clutch C1, the forward/backward travel switching mechanism 24 transmits rotation of the starter output shaft 22 directly to the input shaft 32 of the CVT 30 to cause the vehicle to travel forward. By turning on the brake B1 and turning off the clutch C1, the forward/backward travel switching mechanism 24 converts rotation of the starter output shaft 22 to rotation of a reverse direction and transmits the reverse rotation to the input shaft 32 of the CVT 30 to cause the vehicle to travel backward. The starter output shaft 22 and the input shaft 32 of the CVT 30 can be disconnected by turning off the brake B1 and turning off the clutch Cl. Note that, in the embodiment, the forward/backward travel switching mechanism 24 is formed by the double pinion planetary gear mechanism, the brake B1, and the clutch C1. However, the double pinion planetary gear mechanism of the forward/backward travel switching mechanism 24 may be replaced with a single pinion planetary gear mechanism. Additionally, the forward/backward travel switching mechanism 24 may have another structure as would be recognized by those of ordinary skill in the art.

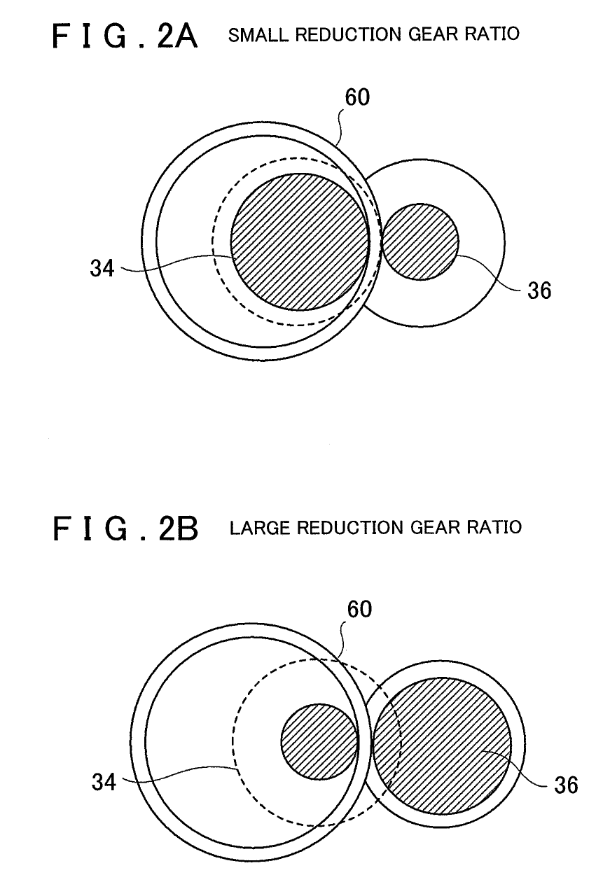

The CVT 30 includes an input cone 34, an output cone 36, a ring 60, a sliding guide (not shown), and a squeezing force adjusting mechanism 50. The input cone 34 has a conical shape, and the input shaft 32 is formed integrally with the input cone 34. The output cone 36 has substantially the same shape as that of the input cone 34 and is connected to the transmission output shaft 38 so as to be disposed in an opposite direction to that of the input cone 34. The ring 60 is inserted around the input cone 34 and is disposed so as to be interposed between the input cone 34 and the output cone 36. The sliding guide rotatably supports the ring 60 and is capable of sliding the ring 60. The squeezing force adjusting mechanism 50 adjusts the squeezing force applied to the ring 60 between the input cone 34 and the output cone 36. By sliding the ring 60 by the sliding guide, the CVT 30 continuously shifts power from the input shaft 32 and outputs the resultant power to the output shaft 36. FIGS. 2A and 2B show shifting states of the CVT 30. As shown in FIG. 2A, by sliding the ring 60 in a direction toward the front surface of the figure, the CVT 30 shifts power from the input cone 34 at a relatively small reduction gear ratio and transmits the resultant power to the output cone 36. Further, as shown in FIG. 2B, by sliding the ring 60 in a direction toward the rear surface of the figure, the CVT 30 shifts power from the input cone 34 at a relatively large reduction gear ratio and transmits the resultant power to the output cone 36.

The input cone 34 and the input shaft 32 are rotatably supported by a bearing 41 at their right end in FIG. 1 and are rotatably supported by a bearing 42 at their left end in FIG. 1. The bearing 41 is attached to the partition plate 21d and is formed as a conical roller that can receive thrust force. The bearing 42 is attached to the transaxle housing 21a and is formed as a cylindrical roller bearing that cannot receive thrust force but can receive relatively large radial force. The output cone 36, on the other hand, is rotatably supported by a bearing 45 at its right end in FIG. 1 and is rotatably supported by a bearing 46 at its left end in FIG. 1. The bearing 45 is attached to the partition plate 21d and is formed as a cylindrical roller bearing. The bearing 46 is attached to the transaxle housing 21a and is formed as a cylindrical roller bearing. The transmission output shaft 38 connected to the output cone 36 is rotatably supported by a bearing 49 at its right end in FIG. 1. The bearing 49 is attached to the converter housing 21b and is formed as a conical roller bearing.

An oil seal 43 is attached to the partition plate 21d on the CVT 30 side (the left side in FIG. 1) from the position where the bearing 41 of the input cone 34 is provided, and an oil seal 47 is attached to the partition plate 21d on the CVT 30 side (the left side in FIG. 1) from the position where the bearing 45 of the output cone 36 is provided. The internal space of the case 21 is thus partitioned into a space (first space) formed by the transaxle housing 21a, the rear cover 21c, and the partition plate 21d and a space (second space) formed by the transaxle housing 21a, the converter housing 21b, and the partition plate 21d. The first space is filled with traction oil for lubricating the bearings 42, 46 disposed in the first space and for transmitting torque in the CVT 30. The second space is filled with lubricating oil for lubricating mechanical portions disposed in the second space such as the bearings 41, 45, 49, the forward/backward travel switching mechanism 24, and the differential gear 28. Accordingly, the first space forms a traction oil chamber and the second space forms a gear oil chamber. The CVT 30 is a mechanism for transmitting power by shearing force of an oil film of an elastohydrodynamic lubricating state formed between the ring 60 and the input cone 34 and the output cone 36. Special oil having a higher pressure-viscosity coefficient than that of the lubricating oil is therefore used as the traction oil. Due to the viscosity coefficient of this traction oil, this traction oil cannot be used to lubricate the bearings 41, 49 formed as conical roller bearings which involve a slipping motion in response to thrust force. However, this traction oil can be used to lubricate the bearings 42, 46 formed as pure rolling cylindrical roller bearings which do not involve a slipping motion. Hereinafter, the reason why the bearings 41, 49 formed as conical roller bearings are disposed in the gear oil chamber and lubricated with the lubricating oil and the bearings 42, 46 formed as cylindrical roller bearings are disposed in the traction oil chamber and lubricated with the traction oil will be described with reference to a comparative example.

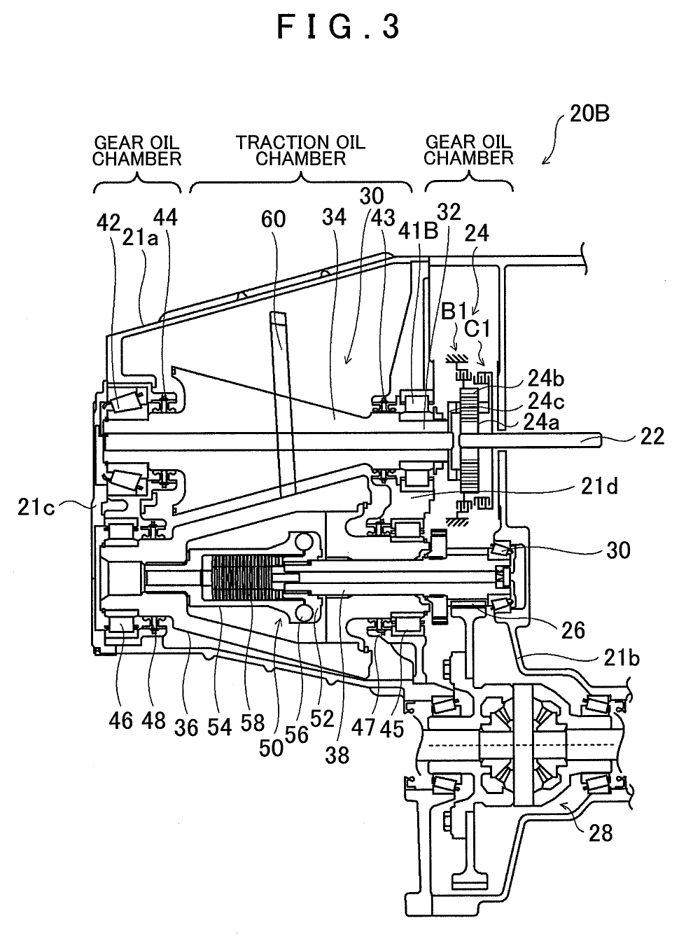

FIG. 3 is a structural diagram showing the outline of a structure of a power transmission device 20B of a comparative example. In the power transmission device 20B of the comparative example, the same structure as that of the power transmission device 20 of the embodiment will be denoted by the same reference numerals and characters and description thereof will be omitted to avoid duplication. In the power transmission device 20B of the comparative example, an input cone 34 and an input shaft 32 are rotatably supported by a bearing 41B at their right end in FIG. 3 and are rotatably supported by a bearing 42 at their left end in FIG. 3. The bearing 41B is formed as a cylindrical roller bearing and the bearing 42 is formed as a conical roller bearing. As described above, since conical roller bearings involve a slipping motion in response to thrust force, it is difficult to lubricate the conical roller bearings with traction oil, and the conical roller bearings need to be lubricated with lubricating oil, which is a non-traction lubricating oil. In the power transmission device 20B of the comparative example, an oil seal 44 for sealing a portion between the bearing 42 formed as a conical roller bearing and a main body of the input cone 34 and an oil seal 48 for sealing a portion between a bearing 46 and a main body of an output cone 36 are attached to a transaxle housing 21a. A space (third space) thus formed by a rear cover 21c and the transaxle housing 21a is filled with lubricating oil and is formed as a gear oil chamber, whereby the bearings 42, 46 are lubricated. This power transmission device 20B of the comparative example can also assure both traction performance and lubrication performance. However, since the space for attaching the oil seals 44, 48 is required, the power transmission device 20B of the comparative example has a larger size in an axial direction and therefore has a larger overall size as compared to the power transmission device 20 of the embodiment described above with reference to FIG. 1. In the embodiment of FIG. 1, the bearings 41, 49 formed as conical roller bearings that need to be lubricated with lubricating oil are disposed in the first space and are lubricated with lubricating oil. The bearings 42, 46 formed as cylindrical roller bearings that can be lubricated even with traction oil are disposed in the second space and are lubricated with traction oil. This structure assures both traction performance and lubrication performance and minimizes a required number of oil seals, thereby achieving reduction in size of the device.

Although not shown in the figure, the sliding guide is structured to be capable of sliding the ring 60 while rotatably supporting the ring 60 along a guide rail formed in the transaxle housing 21a. A slider attached slidably along the guide rail is formed at an upper end of the sliding guide, and two pairs of rollers for rotatably holding the ring 60 are respectively formed at the upper end and a lower end of the sliding guide. In this embodiment, a rod, a lever, and a motor are provided as a slide mechanism. The rod is slidably inserted in a through hole formed in parallel with the guide rail in the lower end of the sliding guide. The lever attached to an end of the rod has a rotation shaft formed in a middle portion of the lever and fixed to the transaxle housing 21a, and has a U-shaped portion formed at the other end. A protruding portion that is inserted into the U-shaped portion of the lever is attached to the motor at an eccentric position from the rotation shaft. By driving and rotating the motor, the rod is tilted up and down to slide the sliding guide. In other words, when the motor is driven and rotated, the lever is caused to swing about the rotation shaft by the protruding portion located at the eccentric position from the rotation shaft. As a result, the rod connected to the lever is tilted in a vertical direction, thereby sliding the ring 60.

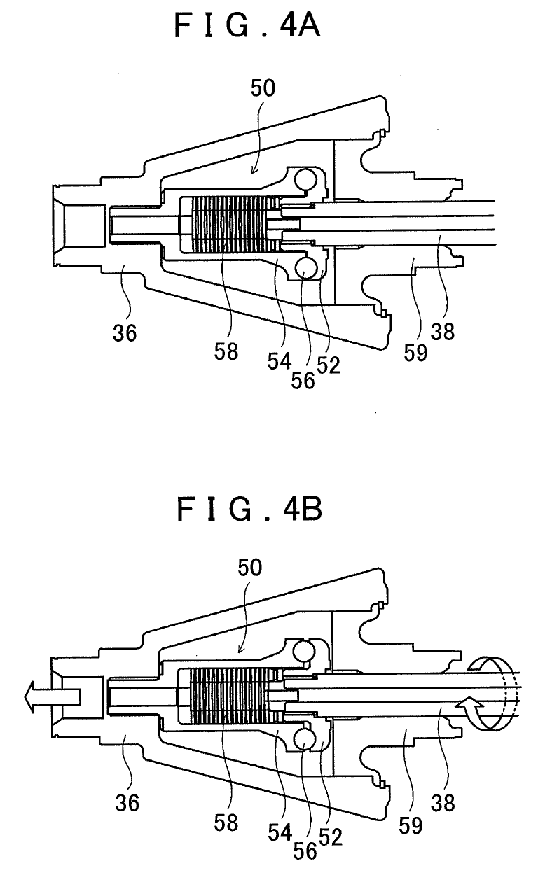

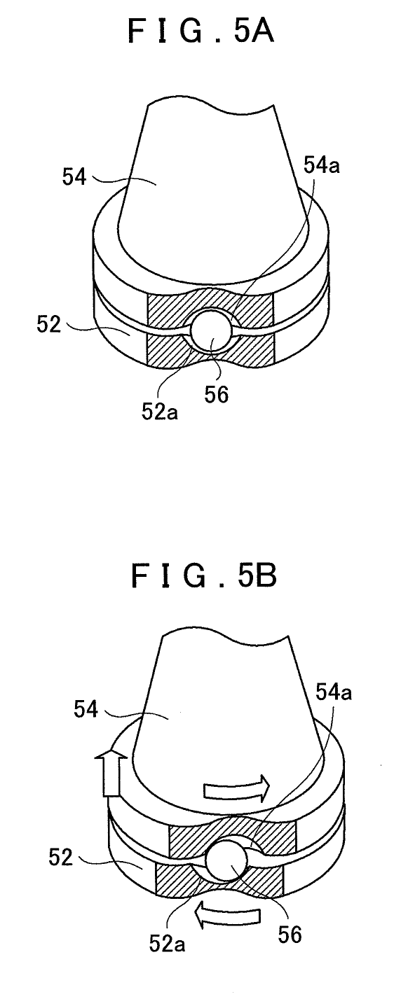

The squeezing force adjusting mechanism 50 is embedded in the output cone 36 and uses a mechanical mechanism to adjust the squeezing force applied to the ring 60 by the input cone 35 and the output cone 36. FIGS. 4A and 4B are structural diagrams showing the outline of a structure of the squeezing force adjusting mechanism 50. FIGS. 5A and 5B show partially enlarged views of the squeezing force adjusting mechanism 50. As shown in these figures, the squeezing force adjusting mechanism 50 includes a fixed member 52, a movable member 54, a plurality of balls 56, a spring 58, and a support member 59. The fixed member 52 is spline-fitted in splines formed in a tip portion of the transmission output shaft 38 and is fixed so as not to be axially movable with respect to the transmission output shaft 38. The movable member 54 is spline-fitted in splines formed in an inner peripheral surface of the output cone 36 and is formed so as to be axially movable together with the output cone 36 with respect to the transmission output shaft 38. The plurality of balls 56 are disposed between a plurality of hemispherical ball receivers 52a formed in the fixed member 52 and a plurality of hemispherical ball receivers 54a formed in the movable member 54. The spring 58 is disposed between the fixed member 52 and the movable member 54 and axially biases the movable member 54 by using the fixed member 52 as a spring bearing. The support member 59 is attached to the output cone 36 and supports the output cone 36 so that the output cone 36 is axially movable with respect to the transmission output shaft 38. The squeezing force adjusting mechanism 50 adjusts the squeezing force to the ring 60 by converting torque applied to the transmission output shaft 38 to axial force and applying the axial force to the output cone 36. As shown in FIG. 5A, when no torque is being applied to the transmission output shaft 38, the ball receiver 52a of the fixed member 52 and the ball receiver 54b of the movable member 54 are located at positions directly facing each other, and the movable member 54 does not receive any force from the ball 56. As shown in FIG. 5B, when torque is applied to the transmission output shaft 38, the ball receiver 52a of the fixed member 52 and the ball receiver 54a of the movable member 54 are twisted with respect to each other, generating a force that pushes the movable member 54 out by the ball 56 by using a reaction force from the fixed member 52. Since the output cone 36 is attached to the movable member 54 as described above, the output cone 36 is also pushed out with the movement of the movable member 54. The larger the torque applied to the transmission output shaft 38 is, the larger the force that pushes out the output cone 36 becomes. The squeezing force to the ring 60 is thus adjusted.

In the power transmission device 20 of the embodiment described above, the partition plate 21d for separating the first space where the CVT 30 is disposed and the second space where the forward/backward travel switching mechanism 24 and the differential gear 28 are disposed is provided in the case 21. The bearings 42, 46 rotatably supporting the input cone 34 and the output cone 36, respectively, and formed as pure rolling cylindrical roller bearings that cannot receive thrust force are disposed in the first space. The bearing 41 rotatably supporting one end of the input shaft 32 and formed as a conical roller bearing that can receive thrust force, the bearing 49 rotatably supporting the transmission output shaft 38 and formed as a conical roller bearing that can receive thrust force, and the bearing 45 rotatably supporting one end of the output cone 36 are disposed in the second space. The first space and the second space are sealed with the oil seals 43, 47. The first space is filled with the traction oil and the second space is filled with the lubricating oil. By thus merely dividing into the two spaces, traction performance of the CVT 30 can be assured by the traction oil, and lubrication performance of the bearings 41, 49 (conical roller bearings), the forward/backward travel switching mechanism 24, and the differential gear 28 which need to be lubricated with the lubricating oil can be assured by the lubricating oil. Moreover, because the parts required the lubricating oil lubrication are disposed in a space (second space) separate from the input cone 34 and the output cone 36, an additive that degrades the traction performance need not be added to the traction oil. As a result, reduction in size of the device can be implemented while assuring both the traction performance and the lubrication performance.

In the power transmission device 20 of the embodiment, the bearings 42, 46 disposed in the first space (the traction oil chamber) are formed as cylindrical roller bearings, and the bearings 41, 49 disposed in the second space (the gear oil chamber) are formed as conical roller bearings. However, the present invention is not limited to this embodiment. Any other bearings can be used as the bearings 42, 46 as long as the bearings can be lubricated with traction oil, and any other bearings can be used as the bearings 41, 49 as long as the bearings can receive thrust force and can be lubricated with lubricating oil.

In the power transmission device 20 of the embodiment, the squeezing force adjusting mechanism 50 is formed by the fixed member 52 attached to the transmission output shaft 38, the movable member 54 attached to the output cone 36, and the plurality of balls 56 respectively provided between the plurality of hemispherical ball receivers 52a formed in the fixed member 52 and the plurality of hemispherical ball receivers 54a formed in the movable member 54. However, the squeezing force adjusting mechanism 50 may be formed by any mechanism as long as the mechanism can convert torque applied to the transmission output shaft 38 into axial force and apply the axial force to the output cone 36. In the power transmission device 30 of the embodiment, the squeezing force adjusting mechanism 50 is embedded in the output cone 36. However, the squeezing force adjusting mechanism 50 may be embedded in the input cone 34 instead of the output cone 36.

In the power transmission device 20 of the embodiment, the input shaft 32 and the input cone 34 are formed integrally. However, the input shaft 32 and the input cone 34 may be formed as separate elements. In this case, the transmission output shaft 38 and the output cone 36 can be formed integrally if the squeezing force adjusting mechanism is provided in the input cone 34 instead of the output cone 36.

Hereinafter, correspondence between the primary elements of the embodiment and modifications thereof and the primary elements of the various aspects of the invention described in the Summary of the Invention will be described. In the embodiment, the input shaft 32 and the input cone 34 correspond to the “input member” and the transmission output shaft 38 and the output cone 36 correspond to the “output member.” The ring 60 corresponds to the “transmitting member.” The sliding guide sliding along the guide rail and the slide mechanism correspond to the “slide unit.” The bearing 41 formed as a conical roller bearing and rotatably supporting one end (the input shaft 32) of the input cone 34 corresponds to the “first bearing” and the bearing 42 formed as a cylindrical roller bearing and rotatably supporting the other end of the input cone 34 corresponds to the “second bearing.” The bearing 49 formed as a conical roller bearing and rotatably supporting the transmission output shaft 38 corresponds to the “third bearing” and the bearing 46 formed as a cylindrical roller bearing and rotatably supporting the output cone 36 connected to the transmission output shaft 38 corresponds to the “fourth bearing.” The case 21 formed by the transaxle housing 21a, the converter housing 21b, the rear cover 21, and the partition plate 21d and partitioned by the oil seals 43, 47 into two spaces, that is, the traction oil chamber accommodating the CVT 30 and the bearings 42, 46 and the gear oil chamber accommodating the bearings 41, 49, the forward/backward travel switching mechanism 24, and the differential gear 28, corresponds to the “case.” The forward/backward travel switching mechanism 24 corresponds to the “rotation switching mechanism.” The differential gear 28 corresponds to the “differential mechanism.” Note that the correspondence between the primary elements of the embodiment and the modifications thereof and the primary elements of the invention described in Summary of the Invention is shown by way of example in order to specifically describe the best modes for the embodiment to carry out the various aspects of the invention as described herein. Accordingly, the above correspondence is merely exemplary and not intended to limit the various aspects of the invention. In other words, the invention described in Summary of the Invention should be construed based on the description given therein, and the embodiment is merely one specific example for carrying out the various aspects of the invention as described herein.

Although the best modes for carrying out the present invention have been described above based on the embodiment, it should be understood that the present invention is not limited in any way to the embodiment described above and can be carried out in various forms without departing from the subject matter of the present invention.

The present invention is applicable in the automobile industry and the like.

What is claimed is:

1. A power transmission device including a continuously variable transmission having an input shaft and an output shaft provided in parallel with the input shaft for continuously shifting power applied to the input shaft and outputting resultant power to the output shaft, comprising:
an input member having a conical shape and including the input shaft;
an output member having substantially the same conical shape as that of the input member, including the output shaft, and disposed in an opposite direction to that of the input shaft;
an annular transmitting member squeezed by the input member and the output member for transmitting power received from the input member to the output member;
a slide unit capable of changing a gear ratio by sliding the annular transmitting member;
a first bearing attached to a first end side of the input member and required to be lubricated with lubricating oil;
a second bearing attached to a second end side of the input member opposite the first end side of the input member, being of a different kind from that of the first bearing, and capable of being lubricated with torque transmitting oil;
a third bearing attached to a first end side of the output member on a same side of the power transmission device as that on which the first bearing is attached, and required to be lubricated with the lubricating oil;
a fourth bearing attached to a second end side of the output member opposite the first end side of the output member, being of a different kind from that of the third bearing, and capable of being lubricated with the torque transmitting oil; and
a case accommodating members of the power transmission device, defining together with a seal member a first space where the input member, the output member, the annular transmitting member, the slide unit, the second bearing, and the fourth bearing are disposed and a second space where the first bearing and the third bearing are disposed, wherein the first space is filled with the torque transmitting oil and the second space is filled with the lubricating oil.

2. The power transmission device according to claim 1, wherein
the first bearing and the third bearing are bearings configured to receive a thrust force, and
the second bearing and the fourth bearing are pure rolling bearings that cannot receive the thrust force.

3. The power transmission device according to claim 2, wherein
the first bearing and the third bearing are conical roller bearings, and
the second bearing and the fourth bearing are cylindrical roller bearings.

4. The power transmission device according to claim 3, wherein
a rotation switching mechanism formed by gears for switching power received from a rotating member between normal rotation and reverse rotation and outputting the resultant power to the input shaft and which is disposed in the second space, wherein in the normal rotation the input shaft rotates in a same direction as the rotating member and in the reverse rotation the input shaft rotates in a different direction from the rotating member.

5. The power transmission device according to claim 4, wherein
a differential mechanism is operatively connected to the output shaft to output power of the output shaft to two other shafts and which is disposed in the second space.

6. The power transmission device according to claim 1, wherein
a rotation switching mechanism formed by gears for switching power received from a rotating member between normal rotation and reverse rotation and outputting the resultant power to the input shaft and which is disposed in the second space, wherein in the normal rotation the input shaft rotates in a same direction as the rotating member and in the reverse rotation the input shaft rotates in a different direction from the rotating member.

7. The power transmission device according to claim 1, wherein
a differential mechanism is operatively connected to the output shaft to output power of the output shaft to two other shafts and which is disposed in the second space.

8. A power transmission device including a continuously variable transmission having an input shaft and an output shaft provided in parallel with the input shaft for continuously shifting power applied to the input shaft and outputting resultant power to the output shaft, comprising:
an input member having a conical shape portion and including the input shaft;
an output member including a conical shape portion having substantially the same conical shape as that of the conical shape portion of the input member, including the output shaft, the conical shape portion disposed in an opposite direction to that of conical shape portion of the input shaft;
an annular transmitting member squeezed by the input member and the output member for transmitting power received from the input member to the output member;
a slide unit capable of changing a gear ratio by sliding the annular transmitting member;
a first bearing attached to a first end side of the input member;
a second bearing attached to a second end side of the input member opposite the first end side of the input member;
a third bearing attached to a first end side of the output member on a same side of the power transmission device as that on which the first bearing is attached;
a fourth bearing attached to a second end side of the output member opposite the first end side of the output member, being of a different kind from that of the third bearing; and
a case accommodating members of the power transmission device, defining together with a seal member a first space where the input member, the output member, the annular transmitting member, the slide unit, the second bearing, and the fourth bearing are disposed and a second space where the first bearing and the third bearing are disposed.

9. The power transmission device according to claim 8, wherein the first space is filled with a torque transmitting oil and the second space is filled with a lubricating oil.

10. The power transmission device according to claim 9, wherein a pressure-viscosity coefficient of the torque transmitting oil is higher than a pressure-viscosity coefficient of the lubricating oil.
